(19) United States
(12) Patent Application Publication
(10) Pub. No.: US 2013/0024543 A1
(43) Pub. Date: Jan. 24, 2013

(54) METHODS FOR GENERATING MULTIPLE RESPONSES TO A SINGLE REQUEST MESSAGE AND DEVICES THEREOF

(71) Applicants: Renji Kuruvilla Thomas, Cochin (IN); Vikrant Raghu, Chennai (IN); Ananth Prasad Konagolli Suresh, Bangalore (IN); Seema Chinmay Albal, Bangalore (IN)

(72) Inventors: Renji Kuruvilla Thomas, Cochin (IN); Vikrant Raghu, Chennai (IN); Ananth Prasad Konagolli Suresh, Bangalore (IN); Seema Chinmay Albal, Bangalore (IN)

(73) Assignee: INFOSYS LIMITED, Bangalore (IN)

(21) Appl. No.: 13/543,203

(22) Filed: Jul. 6, 2012

(30) Foreign Application Priority Data
Jul. 19, 2011 (IN) 2449/CHE/2011

(51) Int. Cl. G06F 15/16

(52) U.S. Cl. 709/217

(57) ABSTRACT

A method, non-transitory computer readable medium, and apparatus that obtains at a first computing apparatus content responsive to a single request message received from a second computing apparatus. Two or more response messages to the single request message are generated with the first computing apparatus. The two or more response messages each comprise a different portion of the content responsive to the single request message. The generated two or more response messages are provided with the first computing apparatus to the second computing apparatus for reconstitution into content responsive to the single content request.

This application claims the benefit of Indian Patent Application Filing No. 2449/CHE/2011, filed Jul. 19, 2011, which is hereby incorporated by reference in its entirety.

### FIELD

This technology generally relates to methods and devices for responding to requests and, more particularly, to methods for generating multiple responses to a single request message and devices thereof.

### BACKGROUND

When a request is received by content provider system from a requesting computing device, such as a laptop computing device, and desktop computing device, a smart phone, or a PDA by way of example only, the web server processes the received request and retrieves the responsive content. A variety of different types and amounts of content could be responsive to the receiving request, such as documents, spreadsheets, web pages, videos, pictures, music, and applications by way of example. Unfortunately, the responsive content to the received request can be quite large.

To manage the transmission of this responsive content, many web servers utilize sessions and caching. Unfortunately, this solution is limited to web servers which are built for this functionality, requires large buffers to be able to service requests from multiple requesting computing devices, and the overall stability and reliability of the transmission of responses decreases as the number of requests increases.

### SUMMARY

A method for generating multiple responses to a single request includes obtaining at the first computing apparatus content responsive to a single request message received from a second computing apparatus. Two or more response messages to the single request message are generated with the first computing apparatus. The two or more response messages each comprise a different portion of the content responsive to the single request message. The generated two or more response messages are provided with the first computing apparatus to the second computing apparatus for reconstitution into content responsive to the single content request.

A non-transitory computer readable medium having stored thereon instructions for generating multiple responses to a single request message comprising machine executable code which when executed by at least one processor, causes the processor to perform steps including obtaining content responsive to a single request message. Two or more response messages to the single request message are generated. The two or more response messages each comprise a different portion of the content responsive to the single request message. The generated two or more response messages are provided for reconstitution into content responsive to the single content request.

A content delivery optimization computing apparatus includes a memory coupled to one or more processors which are configured to execute programmed instructions stored in the memory including obtaining content responsive to a single request message. Two or more response messages to the single request message are generated. The two or more response messages each comprise a different portion of the content responsive to the single request message. The generated two or more response messages are provided for reconstitution into content responsive to the single content request.

This technology provides a number of advantages including providing more effective and reliable methods and devices for providing requested content in response to a single request message. In particular, this technology is configured to divide the responsive content into multiple responses for the single request message. The size of each of the multiple responses is configured based network characteristics relating to the requesting computing device, such as available bandwidth as well as storage and processing capability at the requesting computing device. Additionally, this technology facilitates reconstituting multiple received responses to the single request into the original responsive content. This technology also can be easily incorporated into the capabilities of existing web server devices. Further, this technology does not depend on caching or session techniques and can easily handle huge data transfers based on multiple requests from different requesting computing devices over dedicated channels.

### BRIEF DESCRIPTION OF THE DRAWINGS

FIG. 1 is an environment with an exemplary content provider server device coupled to a requesting client computing device;

FIG. 2 is a functional block diagram illustrating exemplary flow between the content provider server device and the requesting client computing device illustrated in FIG. 1; and

FIG. 3 is a flow chart of an exemplary method for generating multiple responses to a single request message.

### DETAILED DESCRIPTION

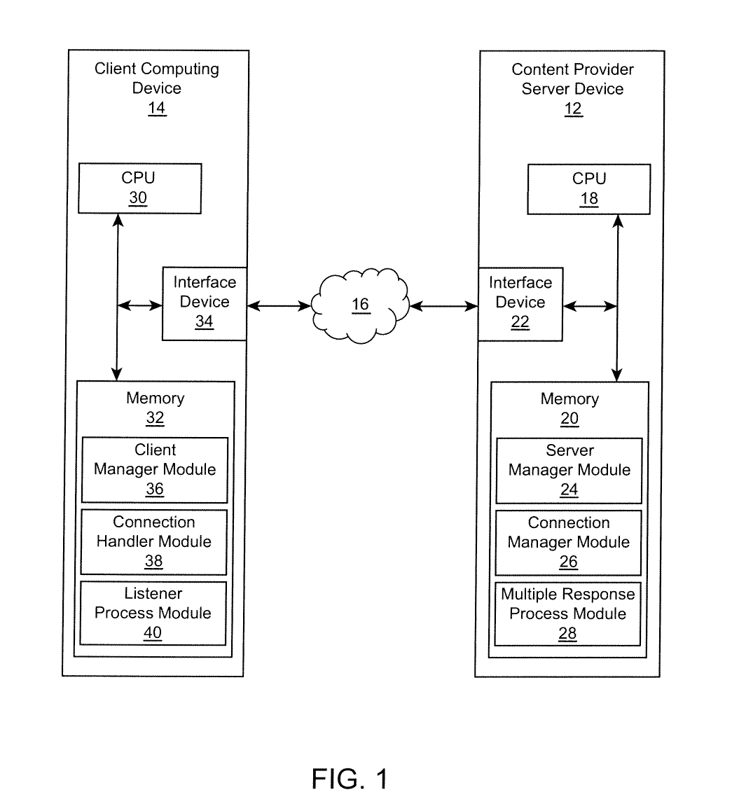

An exemplary environment 10 with a content provider server device 12 coupled to a client computing device 14 by a communication network 16 is illustrated in FIG. 1, although this environment can include other numbers and types of systems, devices, components, and elements in other configurations, such as multiple numbers of content provider server devices and client computing devices. This technology provides a number of advantages including providing more effective and reliable methods and devices for providing requested content in response to a single request message.

The content provider server device 12 includes a central processing unit (CPU) or processor 18, a memory 20, and an interface device 22 which are coupled together by a bus or other link, although other numbers and types of systems, devices, components, and elements in other configurations and locations can be used. The processor 18 in the client computing device 14 executes a program of stored instructions for one or more aspects of the present technology as described and illustrated by way of the examples herein, although other types and numbers of processing devices and logic could be used and the processor could execute other numbers and types of programmed instructions.

The memory 20 in the content provider server device 12 stores these programmed instructions for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

In this particular example, memory 20 in the content provider server device 12 stores programmed instructions for a server manager module 24, a connection manager module 26, and a multiple response process module 28, although the memory 20 in the content provider server device 12 could store other types and numbers of modules and other programmed instructions for execution by the processor 18. The server manager module 24 manages threads started in the content provider server device 12, handles inter thread communication and resource management, and spawns the multiple response process module 28 for each single request message as illustrated and described herein, although the module could implement other types and numbers of functions. The connection manager module 26 includes a connection handler and a connection pool database, although this module could implement other types and numbers of functions. The connection handler includes programmed instructions to authenticate a client to establish a connection, such as client computing device 14, and is responsible for handling multiple connections. The connection pool database is maintained by the connection manager module 26 for multiple client computing devices to track requests/responses of each requesting client computing device. The multiple response process module 28 includes a request handler, a request/response manager, a processing engine and a response sender, although the module could implement other types and numbers of functions. The request handler manages the received single request message, although other types and numbers of functions could be implemented. The request/response manager is responsible for managing the request/response formatting, fragmenting, and decrypting/encrypting, although other types and numbers of functions could be implemented. The processing engine has an application layer interface to through which requests can be received and responses can be sent out, although other types and numbers of functions could be implemented. The response sender manages the transmission of the multiple response messages to the requesting client computing device 14, although other types and numbers of functions could be implemented.

The interface device 22 in content provider server device 12 is used to operatively couple and communicate between the content provider server device 12 and the client computing device 14 via the communications network 16, although other types and numbers of communication networks or systems with other types and numbers of connections and configurations can be used. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The client computing device 14 includes a central processing unit (CPU) or processor 30, a memory 32, and an interface device 34 which are coupled together by a bus or other link, although other numbers and types of systems, devices, components, and elements in other configurations and locations can be used. The processor 30 in the client computing device 14 executes a program of stored instructions for one or more aspects of the present technology as described and illustrated by way of the examples herein, although other types and numbers of processing devices and logic could be used and the processor could execute other numbers and types of programmed instructions.

The memory 32 in the client computing device 14 stores these programmed instructions for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 30, can be used for the memory 32.

In this particular example, memory 20 in the client computing device 14 stores programmed instructions for a client manager module 36, a connection handler module 38, and a listener process module 40, although the memory 20 in the content provider server device 12 could store other types and numbers of modules and other programmed instructions for execution by the processor 18. The client manager module 36 is responsible for controlling components in the client computing device 14, although this module could implement other types and numbers of functions. The connection manager module 38 establishes and manages connections to the listener process module 40 by network protocols, such as TCP/IP or UDP by way of example only, although the module could implement other types and numbers of functions. The listener process module 40 includes a request sender, a response handler, a request/response manager and a processing engine, although the module could implement other types and numbers of functions. The request sender manages the transmission of the single request messages to the content provider server device 12 once the connection is established, although the request sender could implement other types and numbers of functions. The response handler manages the receipt of the multiple response messages from the content provider server device 12, although other types and numbers of functions could be implemented. The request/response manager manages the request/response formatting, fragmenting, and decrypting/encrypting, although other types and numbers of functions could be implemented. The processing engine has an application layer interface through which applications talk to client computing device 14 for sending single request messages and getting back the responses from the content provider server device 12 in the format the requesting application requires, although other types and numbers of functions could be implemented.

The interface device 34 in client computing device 14 is used to operatively couple and communicate between the client computing device 14 and the content provider server device 12 via the communications network 16, although other types and numbers of communication networks or systems with other types and numbers of connections and configurations can be used. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

Although examples of the content provider server device 12 and the client computing device 14 which are coupled together via the communication network 16 are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer device or devices that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

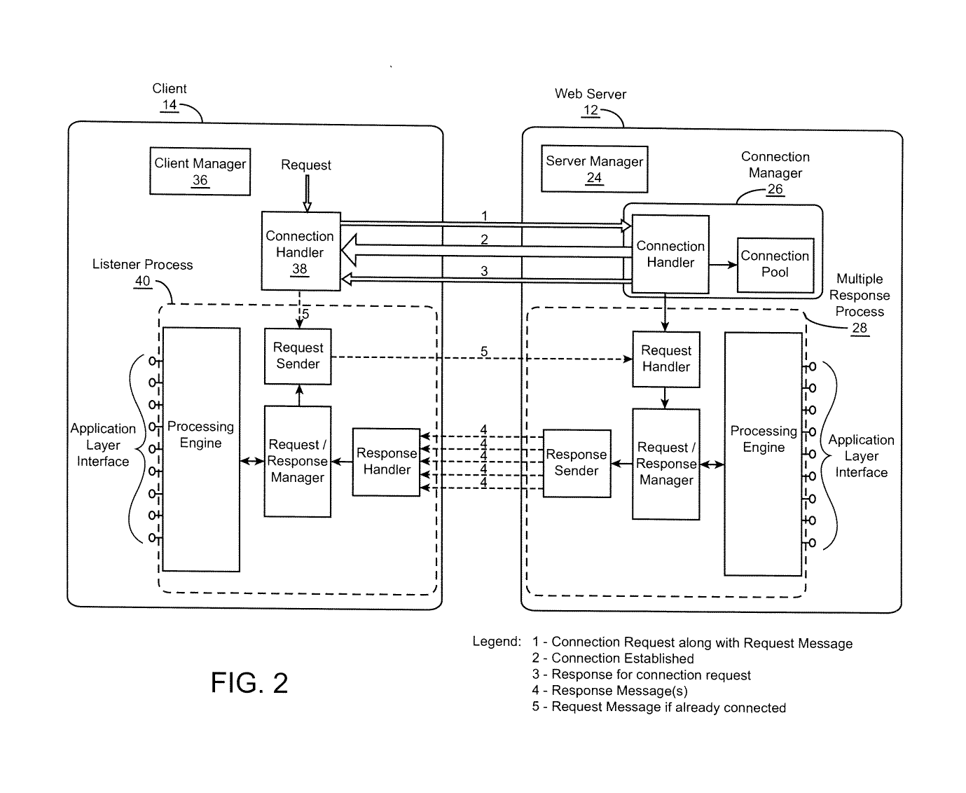

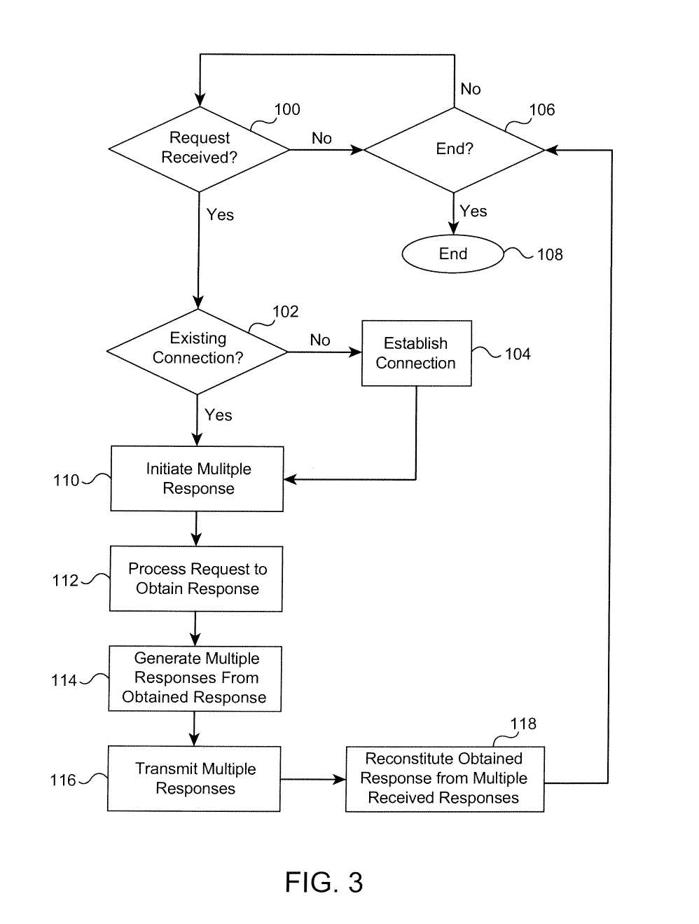

An exemplary method for generating multiple responses to a single request message will now be described with reference to FIGS. 1-3. In step 100, the listener process module 40 is engaged in the client computing device 14 to monitor for one or more request messages from one or more executing applications via the application layer interface in the processing engine of the listener process module 40, although other manners for determining if a request message has been received could be used, such as having the content provider server device 12 monitor for a request message by way of example only. If in step 100, the listener process module 40 in the client computing device 14 detects a request message, then the Yes branch is taken to step 102.

In step 102, the connection handler module 38 is engaged in the client computing device 14 to determine whether there is an existing connection with the content provider server device 12 for the received request message, although other manners for determining if there is an existing connection could be used, such as having the content provider server device 12 determine if there is an existing connection with the client computing device 14 by way of example only. If in step 102, the client computing device determines there is no existing connection with the content provider server device 12, then the No branch is taken to step 104.

In step 104, the connection handler module 38 in the client computing device 14 uses the connection request associated with the received request message to interact with the connection handler module 26 in the content provider server device 12 to establish a connection, although other manners for establishing a connection can be used. The connection handler module 26 in the content provider server device 12 authenticates the client computing device 14 associated with the connection request and the received request message, although other manners for authenticating and establishing the connection can be used.

If back in step 100, the listener process module 40 in the client computing device 14 does not detect a request message, then the No branch is taken to step 106. In step 106, the client computing device 14 determines whether to disengage the listener process module 40 and end this method, although other manners for determining whether to end could be used, such as with the content provider server device 12. If in step 106, a determination is made to end this method then the Yes branch is taken to step 108 where this method ends. If in step 106, a determination is made to continue this method, then the Yes branch is taken back to step 100 as described earlier.

Referring back to step 102, if the client computing device 14 determines there is an established connection with the content provider server device 12, then the Yes branch is taken to step 110. In step 110, the content provider server device 12 engages the multiple response process module 28 in response to the single received request message, although other manners for initiating the multiple response process module could be used

In step 112, the received request message is passed to the request/response manager in the multiple response process module 28 in the content provider server device 12 for processing. In this particular example, the single received request message is an HTTP request, although requests in other formats could be used. More specifically, the request/response manager in the multiple response process module 28 in the content provider server device 12 manages the formatting, fragmenting, and/or decrypting of the received request message, although other types of processing to obtain the response to the received request message can be executed. The application layer interface of the processing engine in the multiple response process module 28 passes out the processes request and obtains the corresponding original response.

In step 114, the request/response manager in the multiple response process module 28 in the content provider server device 12 receives the corresponding original response via the application layer interface in the processing engine of the multiple response process module 28 and generates two or more responses to the respond to the single received request message. In this particular example, the multiple response messages are each HTTP responses, although responses in other formats could be used. More specifically, in this particular example the content provider server device 12 is configured with data stored in memory regarding one or more parameters related to the established connection and to the client computing device 14, although other manners for obtaining the one or more parameters could be used. By way of example only, the content provider server device 12 could be configured to determine the one or more parameters by analyzing one or more characteristics relating to the established connection and/or the client computing device 14, such as the current network bandwidth, connection speed, connection quality, processing capability at the client computing device and memory and/or caching capacity at the client computing device. Based on the obtained one or more parameters, the request/response manager in the multiple response process module 28 determines a size for each of the multiple responses for the single request message. Next, the request/response manager in the multiple response process module 28 divides the responsive content based on the determined size and generates two or more responses for the single request message in an appropriate format for transmission to the client computing device 14. Next, the request/response manager in the multiple response process module 28 may optionally encrypt the multiple responses prior to transmission to the client computing device 14.

In step 116, the response sender in the multiple response process module 28 in the content provider server device 12 receives and transmits the generated multiple responses for the single request message to the response handler in the listener process module 40 in the client computing device 14, although other manners for transmitting the multiple messages could be used.

In step 118, the request/response manager in the listener process module 40 in the client computing device 14 decrypts the received multiple responses (if encryption was used), formats if necessary, and reconstitutes the multiple responses into the original responsive content, although other manners for reconstituting the original responsive content can be used. The request/response manager in the listener process module 40 in the client computing device 14 provides the reconstituted original responsive content which is passed out to the requesting application via the application layer interface. Next, the process returns back to step 106 as described earlier.

Accordingly, as illustrated and described with the example herein this technology more effective and reliable methods and devices for providing requested content in response to a single request message. In particular, this technology is configured to divide the responsive content into multiple responses for the single request message. The size of each of the multiple responses is configured based network characteristics relating to the requesting computing device, such as available bandwidth as well as storage and processing capability at the requesting computing device. Additionally, this technology facilitates reconstituting multiple received responses to the single request into the original responsive content. This technology also can be easily incorporated into the capabilities of existing web server devices. Further, this technology does not depend on caching or session techniques and can easily handle huge data transfers based on multiple requests from different requesting computing devices over dedicated channels.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for generating multiple responses to a single request, the method comprising:
obtaining at a first computing apparatus content responsive to a single request message received from a second computing apparatus;
generating with the first computing apparatus two or more response messages to the single request message, the two or more response messages each comprising a different portion of the content responsive to the single request message; and
providing with the first computing apparatus the generated two or more response messages to the second computing apparatus for reconstitution into content responsive to the single content request.

2. The method as set forth in claim 1 further comprising:
receiving at the first computing apparatus a connection request with the single request message from the second computing apparatus; and
establishing with the first computing apparatus a first connection with the second computing apparatus in response to the received connection request.

3. The method as set forth in claim 2 wherein the generating further comprises:
identifying with the first computing apparatus at least one network parameter relating to the established connection and the second computing apparatus; and
determining with the first computing apparatus a size of each of the different portions of the content responsive to the single request message based on the identified parameter, wherein the generating the two or more response messages to the single request message is based on the determined size.

4. The method as set forth in claim 2 further comprising:
receiving at the first computing apparatus a subsequent single request message from the second computing apparatus;
identifying by the first computing apparatus an existing established connection with the second computing apparatus, wherein the obtaining, the generating and the providing are executed with respect to the subsequent single request message utilizing the existing established connection between the first computing apparatus and the second computing apparatus.

5. The method as set forth in claim 2 wherein the receiving at the first computing apparatus the connection request further comprises authenticating by the first computing apparatus of the second computing apparatus before the establishing of the first connection.

6. The method as set forth in claim 1 wherein the obtaining with the first computing apparatus content responsive to the single request message further comprises:
decrypting with the first computing apparatus the single request message; and
processing with the first computing apparatus the decrypted single request message to obtain the content responsive to the single request message.

7. The method as set forth in claim 1 wherein the generating with the first computing apparatus further comprises encrypting the generated two or more response messages to the single request message before the providing.

8. A non-transitory computer readable medium having stored thereon instructions for generating multiple responses to a single request message comprising machine executable code which when executed by at least one processor, causes the processor to perform steps comprising:
obtaining content responsive to a single request message;
generating two or more response messages to the single request message, the two or more response messages each comprising a different portion of the content responsive to the single request message; and
providing the generated two or more response messages for reconstitution into content responsive to the single content request.

9. The medium as set forth in claim 8 further comprising:
receiving a connection request with the single request message; and
establishing a first connection in response to the received connection request.

10. The medium as set forth in claim 9 wherein the generating further comprises:
identifying at least one network parameter relating to the connection request and a computing apparatus which provided the connection request; and
determining a size of each of the different portions of the content responsive to the single request message based on the identified parameter, wherein the generating the two or more response messages to the single request message is based on the determined size.

11. The medium as set forth in claim 9 further comprising:
receiving a subsequent single request message;
identifying an existing established connection, wherein the obtaining, the generating and the providing are executed with respect to the subsequent single request message utilizing the existing established connection.

12. The medium as set forth in claim 9 wherein the receiving the connection request further comprises authenticating the connection request before the establishing of the first connection.

13. The medium as set forth in claim 8 wherein the obtaining content responsive to the single request message further comprises:
decrypting the single request message; and
processing the decrypted single request message to obtain the content responsive to the single request message.

14. The medium as set forth in claim 8 wherein the generating further comprises encrypting the generated two or more response messages to the single request message before the providing.

15. A content delivery optimization computing apparatus comprising:
one or more processors;
a memory coupled to the one or more processors which are configured to execute programmed instructions stored in the memory comprising:
obtaining content responsive to a single request message;
generating two or more response messages to the single request message, the two or more response messages each comprising a different portion of the content responsive to the single request message; and
providing the generated two or more response messages for reconstitution into content responsive to the single content request.

16. The apparatus as set forth in claim 15 wherein the one or more processors is further configured to execute programmed instructions stored in the memory further comprising:
receiving a connection request with the single request message; and
establishing a first connection in response to the received connection request.

17. The apparatus as set forth in claim 16 wherein the one or more processors is further configured to execute programmed instructions stored in the memory for the generating further comprises:
identifying at least one network parameter relating to the connection request and a computing apparatus which provided the connection request; and
determining a size of each of the different portions of the content responsive to the single request message based on the identified parameter, wherein the generating the two or more response messages to the single request message is based on the determined size.

18. The apparatus as set forth in claim 16 wherein the one or more processors is further configured to execute programmed instructions stored in the memory further comprising:
receiving a subsequent single request message;
identifying an existing established connection, wherein the obtaining, the generating and the providing are executed with respect to the subsequent single request message utilizing the existing established connection.

19. The apparatus as set forth in claim 16 wherein the one or more processors is further configured to execute programmed instructions stored in the memory for the receiving the connection request further comprises authenticating the connection request before the establishing of the first connection.

20. The apparatus as set forth in claim 15 wherein the one or more processors is further configured to execute programmed instructions stored in the memory for the obtaining content responsive to the single request message further comprises:
decrypting the single request message; and
processing the decrypted single request message to obtain the content responsive to the single request message.

21. The apparatus as set forth in claim 15 wherein the one or more processors is further configured to execute programmed instructions stored in the memory for the generating further comprises encrypting the generated two or more response messages to the single request message before the providing.
